(19) United States
(12) Patent Application Publication
(10) Pub. No.: US 2012/0021229 A1
(43) Pub. Date: Jan. 26, 2012

(54) PROCESS FOR EXTENDING POLYURETHANE BINDERS WITH WATER

(76) Inventor: Robert Dunham Cunningham, Maryland Heights, MO (US)

(21) Appl. No.: 13/190,072

(22) Filed: Jul. 25, 2011

Related U.S. Application Data
(60) Provisional application No. 61/367,219, filed on Jul. 23, 2010.

(51) Int. Cl. B32B 27/00; C08K 5/06; C08K 5/11; C08L 75/04

(52) U.S. Cl. 428/423.1; 524/591; 524/375; 524/310; 523/122

(57) ABSTRACT

This disclosure provides a process to produce a moisture-curable polyurethane binder composition comprising: providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; adding a non-ionic surfactant to the first mixture; and adding water to the first mixture to form an emulsion, wherein the moisture-curable polyurethane binder composition contains about 3% to about 25% residual isocyanate functionality.

### CROSS-REFERENCE TO RELATED PATENT APPLICATION

This application claims the benefit of U.S. provisional application Ser. No. 61/367,219, filed Jul. 23, 2010, which is incorporated in its entirety herein by reference.

### FIELD

The present disclosure generally relates to processes for preparing binder compositions, compositions prepared by such processes, and products containing such compositions. More particularly, the present disclosure relates to processes for extending prepolymer compositions with nonreactive diluents and stabilizing mixtures of such compositions with surfactants, binder compositions prepared by such processes, and articles comprising such binder compositions.

### BACKGROUND

This section provides information related to the present disclosure which is not necessarily prior art.

Polyurethane binders and adhesives are used extensively to combine particulate materials into solid form through a molding process. Typical particulate materials may include, but are not limited to, rubber granules, flexible polyurethane foam, and granulated cork. Rubber granules may often be obtained from recycled tires and can be used to produce molded flooring and material for mechanical goods. Flexible polyurethane foam may be obtained from a variety of recycled sources and can be often used to produce floor underlayment, including resilient carpet pads. Granulated cork may also be used in flooring products.

An active binding ingredient is generally composed of the product generated from the reaction of a polyol and an isocyanate. In many instances, isocyanates may not completely react and residual isocyanate functionality remains in the binder. This isocyanate-functionalized prepolymer can be mixed with particulate material to be combined and the resulting prepolymer/particulate mixture can be compressed into a final form. The excess isocyanate functionalities may be cured by moisture reaction with water, which may be derived from the residual moisture retained on or within the particulates, from liquid introduced during the mixing of prepolymer and particulate material, from steam introduced into the mold during processing, or any combination of these.

In many instances, prepolymers can be diluted, or extended, with inert liquid diluents such as plasticizers or hydrocarbon oils, typically at levels from 5% to 50% by weight of the active prepolymer component. Inert plasticizers are relatively nonvolatile liquid additives derived from petrochemical sources which decrease the viscosity of the prepolymer without substantially changing the material's other properties. Hydrocarbon oils are additives often derived from petroleum and containing substantially only carbon and hydrogen atoms. These hydrocarbon oils can also decrease the viscosity of the prepolymer without typically substantially changing the material's other properties.

However, many inert plasticizers and hydrocarbon oils may be classified as or may release toxic volatile organic compounds (VOCs), raising environmental and health concerns. Long-term exposure to VOCs in an indoor environment, such as an office or home, can contribute to sick building syndrome (SBS) and allergic sensitization. Many building materials, such as paints, adhesives, wall boards, and ceiling tiles, emit formaldehyde, which irritates mucosal membranes and can cause discomfort. Other sources of VOCs in the office include new furnishings, wall coverings, and office equipment. Eliminating VOCs from bonded foam products used in furnishings, flooring products, wall coverings, ceiling tiles, and office equipment would constituted a technological advantage as well as significantly improving indoor air quality.

The primary purposes of extension or dilution may be to reduce cost, to decrease viscosity, and to expand physical volume. Cost is reduced because plasticizers and hydrocarbons are substantially less expensive than most active prepolymer ingredients. Viscosity, or thickness of the fluid, is decreased in the active prepolymer ingredient to promote rapid and uniform mixing with the particulate materials to be combined. Physical volume of the prepolymer mixture is expanded to provide enough liquid to coat the high surface areas of the particulate material at the levels normally used for addition, which are typically 2.5% to 20% by weight. Mixing the plasticizer or hydrocarbon oil diluent with the polyol and isocyanate active ingredients incorporates it into the binder. Typically the entire mixture is polymerized in situ. The final product is a diluted liquid prepolymer or diluted liquid binder ready for use in the particulate bonding or rebonding process.

Currently, some isocyanates and isocyanate prepolymers are treated with various chemical species to impart to the active ingredients water solubility, dispersability, or both. Common chemical treatments are ethylene oxide monols and dimethylol propionic acid. These water-soluble chemicals react with isocyanates and make them water-soluble. The treatments are usually complex and costly because the isocyanate is typically reacted with the water-soluble chemical species during prepolymer manufacture. Additionally, these water-soluble chemicals are generally quite expensive, and alternative technologies would be attractive for their economy. In most instances, a completely reacted polyurethane polymer emulsion or dispersion is generated, which has analogous properties and uses to rubber or acrylic emulsions. These emulsions, while stable in water, are composed of high molecular weight polymers which form films when the water is evaporated rather than being reactive species that form a polymer matrix by in situ reaction of residual isocyanate functionalities. For this reason, water-extended polyurethane emulsions or dispersions are not typically used for particulate rebonding processes.

U.S. Pat. No. 3,781,238 describes a method for forming a stable aqueous dispersion consisting essentially of water, diisocyanate, polyether polyol, non-ionic surfactant, and tertiary aminopolyol. In this method, the isocyanate-polyol prepolymer is first emulsified in water with a non-ionic surfactant, then a tertiary aminopolyol is added to stabilize said isocyanate-free emulsion.

U.S. Pat. No. 4,554,308 describes an aqueous ionic dispersion of cross-linked polyurethane particles. A polyfunctional hydrogen compound containing ionically neutralizable solubilizating groups is reacted with diisocyanate to form a non-crosslinked, ungelled prepolymer, which is then chain-extended to form an isocyanate-free ionic dispersion of crosslinked polyurethane in water.

U.S. Pat. No. 5,432,204 describes a process comprising providing a first mixture consisting essentially of water, catalyst, and filler material, such as particulate material; providing a second mixture comprising isocyanate-polyol prepolymer; and contacting the first and second mixture. The filler material uniformly distributes within the foamed isocyanate-based polymer.

### SUMMARY

This section provides a general summary of the disclosure, and is not a comprehensive disclosure of its full scope or of all its features.

The present disclosure provides a process to produce a moisture-curable polyurethane binder composition, comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species;
mixing the first mixture and a second mixture comprising a non-ionic surfactant and water to form an emulsion,
wherein the moisture-curable polyurethane binder composition contains about 3% to about 25% residual isocyanate functionality.

In an embodiment, there is provided a polyurethane binder prepared by a process comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising a non-ionic surfactant and water to form an emulsion,
wherein the moisture-curable polyurethane binder composition contains about 3% to about 25% residual isocyanate functionality.

In another embodiment, there is provided a molded article prepared by a process comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species;
mixing the first mixture and a second mixture comprising a non-ionic surfactant and water to form an emulsion, wherein the moisture-curable polyurethane binder composition contains about 3% to about 25% residual isocyanate functionality;
applying the moisture-curable polyurethane binder composition to a particulate material to be combined; and
curing the moisture-curable polyurethane binder composition and the particulate material.

In another embodiment, there is provided a process to produce a moisture-curable polyurethane binder composition consisting essentially of:
providing a first mixture comprising an isocyanate-containing species and a polyfunctional polyol, wherein the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising a non-ionic surfactant and water to form an emulsion, wherein the moisture-curable polyurethane binder composition contains about 3% to about 25% residual isocyanate functionality.

In yet another embodiment, there is provided a process to produce a moisture-curable polyurethane binder composition comprising:
providing a first mixture comprising an isocyanate-containing species and a polyfunctional polyol, wherein the isocyanate-containing species is a difunctional or polyfunctional isocyanate and wherein the isocyanate-containing species and the polyfunctional polyol are reacted to form an isocyanate-functionalized species;
adding a non-ionic surfactant to the first mixture; and
adding water to the first mixture to form an emulsion, wherein the moisture-curable polyurethane binder composition contains about 3% to about 25% residual isocyanate functionality.

Further areas of applicability will become apparent from the description provided herein. This summary is intended for purposes of illustration only and is not intended to limit the scope of the present disclosure.

### DETAILED DESCRIPTION

A process in accordance with the present disclosure can be used to substitute water for the inert plasticizer or hydrocarbon oils used to dilute, extend, or disperse active prepolymer ingredients.

“Binder” refers to a compound used to promote uniformity, consistency, solidification, or cohesion in and among other material. A binder can also be used as an adhesive, which is a substance that causes two or more surfaces to stick together. A process of mixing binder or binder compositions with materials to be combined can be referred to in many ways, including, but not limited to, binding, bonding, rebonding, combining, recombining, and incorporating.

“Moisture” refers to the presence of water, including water in trace amounts, steam, humidity, and liquid water. “Moisture-curable” describes a chemical or composition (in this case a polyurethane binder) that cross-links, polymerizes, or has functional groups which react in the presence of moisture. In some embodiments, moisture is provided in the form of steam.

“Hydrophilic” refers to a compound which mixes easily with or interacts significantly with water. “Hydrophobic” refers to a compound which does not mix easily with water or interacts very little with water, often remaining separate when mixing is attempted. “Amphiphilic” refers to a compound which has both hydrophilic and hydrophobic properties, and thus, is able to interact significantly with both hydrophilic compounds and with hydrophobic compounds.

“Particulate material” refers to any matter, substance, or material which is predominately granular or divided into small pieces. For example, a particulate material includes, but is not limited to, rubber, foam scrap, plastic, paper, wood, stone, and metal. Obtaining particulate material may involve a step of chopping, grinding, cutting or abrading the solid material into a particulate mixture. Generally, a wide range of granule sizes in the particulate matter may be used in a composition of the present disclosure. Under certain circumstances, depending on the characteristics of the final product, it may be necessary or advantageous to control granule size.

Particulate material includes foam, and many materials can comprise foam, including, but not limited to, polyurethane (foam rubber) and polystyrene (extruded polystyrene foam and Styrofoam™). A foam can be low density, high density, microcellular or elastomeric. A low density bonded foam product can have many uses, including, but not limited to, high resiliency foam for bedding and upholstery, packaging foam, and insulation foam. A high density bonded foam product can be used for footwear midsoles, footwear outsoles, integral skin for vehicle interiors or simulated wood. A microcellular and elastomeric bonded foam can be used for fabric coating, synthetic fiber, vehicle fascia, vehicle exterior or structural foam. Any foam can be flexible, semi-rigid or rigid. A flexible bonded foam can be used for upholstery fabric, commercial furniture, domestic furniture or carpet pad. A rigid bonded foam can be used for insulation in appliances and in buildings.

“Polyol” refers to a polymer or oligomer containing a large number of hydroxyl (—OH) groups. Two important characteristics of a polyol are its functionality and its hydroxyl number. The functionality is a measure of the ability of a polyol to form covalent bonds with another molecule or group in a chemical reaction, expressed in terms of the number of functional groups capable of participating in the reaction, such as 1, 2, 3, 4 or more. A difunctional polyol contains 2 functional groups capable of participating in the reaction, and a polyfunctional polyol contains 3 or more functional groups capable of participating in the reaction. In the definition of polyol, the terms “glycol” and “oxide” may often be used interchangeably to denote a polyethereal structure. Polyol can exist in a wide range of molecular weights. Polyol includes, but is not limited to, polyether polyol, polyester polyol, polymer polyol, polybutadiene polyol, castor oil base polyol, soya oil base polyol, and polyhydroxy-containing compounds.

An isocyanate reacts with the hydroxyl groups of a polyol and with water to polymerize the polymer and bind particulate material. Isocyanate includes, but is not limited to, toluene diisocyanate (TDI), diphenylmethane diisocyanate (MDI), polymeric methylene-4,4′-diphenyl diisocyanate (PMDI, also know as polymeric diphenylmethane diisocyanate), hexamethylene diisocyanate (HDI) isophorone diisocyanate (IPDI), dicyclohexylmethane diisocyanate, m-phenylene diisocyanate, p-phenylene diisocyanate, polymethylene polyphenyl-isocyanate, 2,4-toluene diisocyanate, 2,6-toluene diisocyanate, 4,4-diisocyanatodiphenyl methane, dianisidine diisocyanate, bitolylene diisocyanate, naphthalene-1,4-diisocyanate, diphenylene-4,4′-diisocyanate, xylylene-1,4-diisocyanate, xylylene-1,2-diisocyanate, xylylene-1,3-diisocyanate, bis(4-isocyanato-phenyl)-methane, bis(3-methyl-4-isocyanatophenyl)-methane, 4,4-diphenylpropane diisocyanate, methylene-bis-cyclohexylisocyanate, and any mixture thereof.

“Surfactant” refers to a wetting agent that lowers the surface tension of a liquid and the interfacial tension between two liquids, allowing easier spreading. Alternative terms for surfactant include, but are not limited to, detergent, emulsifier, dispersant, and defoamer. A surfactant may often be amphiphilic, containing both hydrophobic and hydrophilic functionalities. A surfactant may be ionic or non-ionic.

Ionic surfactant includes anionic surfactant, cationic surfactant and zwitterionic surfactant. An anionic surfactant can be based on sulfate, sulfonate or carboxylate anions and includes, for example, perfluorooctanoate (PFOA or PFO), perfluoroooctanbsulfonate (PFOS), and sodium dodecyl sulfate (SDS). A cationic surfactant can be based on quaternary ammonium cations and includes, for example, cetyl trimethylammonium bromide (CTAB), cetylpyridinum chloride (CPC), and polyethyloxylated tallow amine (POEA). A zwitterionic surfactant, or amphoteric surfactant, contain both a positive and a negative charge and includes, for example, dodecyl betaine, cocamidopropyl betaine, and cocoamphoglycinate.

Non-ionic surfactant contains only neutral chemical groups and includes, but is not limited to, alkyl poly(ethylene oxide), alkylphenol poly(ethylene oxide), copolymer of poly(ethylene oxide), copolymer of poly(propylene oxide) alkyl polyglucoside, fatty alcohol, polysorbate, and any mixture thereof.

Most commercially available polyol and isocyanate prepolymers are hydrophobic, making them water immiscible unless non-ionic surfactant or other hydrophilic agent is chemically reacted into the prepolymer. Adding a suitable surfactant into the water during processing allows for rapid formation of a stable water emulsion or dispersion of the active species. A suitable choice of ingredients used in the isocyanate-functionalized prepolymers and of the surfactant added to the aqueous phase produce a two-component mixture that is rapidly emulsified using conventional mixing equipment. The resulting isocyanate-functionalized prepolymer water dispersion meets the felt need in the art by being less expensive than current practice, by having sufficiently low viscosity to promote rapid incorporation, having sufficient volumes to adequately coat the particulate material, and being sufficiently stable to be incorporated into the particulate material.

In preparing a binder composition with a process in accordance with this disclosure, the components of the binder composition can be mixed together in a mixer. The term “mixer” refers to a machine that thoroughly blends substances into mixtures, solutions, suspensions, colloids, gels, and emulsions. Mixing can be achieved with any conventional mixer. Mixers used for the process include, but are not limited to, tanks equipped with a suitable mechanical stirrer, static mixer, dynamic mixer, high intensity mechanical mixer, colloidal mill, high intensity mechanical emulsifier, impingement mixer, and an agitator. Any of these mixers can be batch or in-line.

“Pressure” refers to the force per unit area applied to an object perpendicular to the surface. “High pressure” refers to pressures greater than atmospheric pressure, which is typically 14.7 pounds-per-square-inch (psi).

“Shear stress” refers to a stress which is applied parallel or tangential to a face of a material, as opposed to a normal stress, such as pressure, which is applied perpendicularly to a face of a material. “Stress” refers to a measure of average force exerted per unit surface area within a deformable body; that is, “stress” refers to a measure of the intensity, or internal distribution, of the total internal forces acting within a deformable body across imaginary surfaces within that body. “Shear” or “shear strain” is induced by shear stress and refers to a deformation of a material in which parallel internal surfaces slide past one another.

“Deformation” refers to a change in shape or size over time of a continuous body after it is displaced from an initial configuration to a new configuration.

This disclosure provides a process to produce a moisture-curable polyurethane binder composition comprising: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; mixing the first mixture and a second mixture comprising a non-ionic surfactant and water to form an emulsion, wherein the moisture-curable polyurethane binder composition contains about 3% to about 25% residual isocyanate functionality.

A process to make a moisture-curable polyurethane binder composition in accordance with this disclosure may not need treatments with water-soluble chemicals to make isocyanates water-soluble because adding a surfactant can substantially substitute for such treatments. One of the advantages of water dilution is cost reduction, since water is very inexpensive compared to commonly used plasticizer and active prepolymer ingredients. Water dilution can also eliminate the need for other chemicals such as plasticizers, hydrocarbon oils, fillers, organic dispersing media or tertiary aminopolyol stabilizers in the product, making the product friendlier to the environment. Not relying upon hydrocarbon-based plasticizers, fillers, and dispersing media also eliminates a potential source of VOCs. The elimination of VOCs, as discussed above, unquestionably improves indoor air quality and the health of those occupying that environment. Water used in the present process can be common tap water, which is freely available and very inexpensive. In an embodiment, a process to make a moisture-curable polyurethane binder composition is carried out without essentially adding an additional chemical other than a non-ionic surfactant to a prepolymer of an isocyanate-containing species and a polyol component prior to adding water.

Directly mixing water into a reactive isocyanate-containing species is typically disfavored because isocyanates are highly water-reactive. However, because most urethane binder-based particulate bonding operation cycles are extremely short, the reaction rate between the isocyanate and water mixture is too slow to effect the components when mixed immediately before incorporation into the particulate mixture. A relatively fragile and unstable emulsion that breaks down fairly rapidly does not permit the water phase to interact efficiently with the prepolymer phase. This phase segregation slows reaction between the water and prepolymer, producing an emulsion with better retention of free isocyanate content over a longer period of time. By use of a process disclosed herein, a prepolymer emulsion still possesses isocyanate-containing species, and thus, remains moisture-curable and suitable for recombining particulate material.

Polyol is a component of a prepolymer mixture to react with water and a non-ionic surfactant. Generally, any multifunctional polyol may be suitable for use in a disclosed process. In an embodiment, polyol to be used in a process is selected from the group consisting of poly(tetramethylene glycol) polymer, poly(propylene glycol), copolymer of propylene glycol and ethylene glycol, poly(ethylene glycol), polybutadiene glycol, castor oil base polyol, soya oil base polyol, and polyhydroxy-containing compounds.

In another embodiment, polyol is selected from the group consisting of difunctional polypropylene glycol, polyfunctional polypropylene glycol, and any copolymer thereof. In yet another embodiment, polyol is a polyfunctional copolymer of propylene oxide and ethylene oxide.

Diisocyanate is another component of a prepolymer mixture to react with water and a non-ionic surfactant. Generally, any diisocyanate may be suitable for use in a disclosed process. In an embodiment, an isocyanate-containing species to be used in a process is selected from the group consisting of TDI, MDI, PMDI, HDI, IPDI, dicyclohexylmethane diisocyanate, and any mixture thereof. In another embodiment, an isocyanate-containing species is selected from the group consisting of MDI, PMDI, and any mixture thereof.

A surfactant is a component added to a prepolymer mixture of a polyol and a diisocyanate as a mixture with water or a separate component added before addition of water. Any non-ionic surfactant may be used in a process disclosed herein. In some embodiments, a non-ionic surfactant contains a compound selected from the group consisting of:

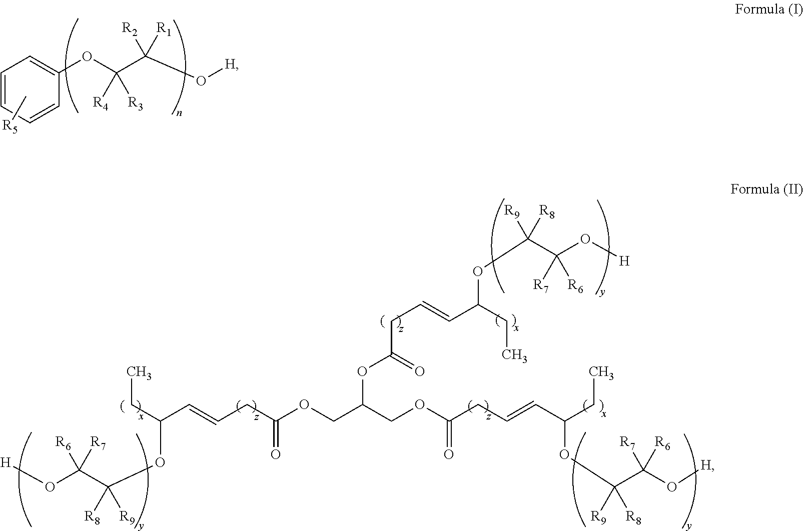

and a mixture thereof, wherein R₁, R₂, R₃, R₄, R₅, R₆, R₇, R₈, and R₉ are independently selected from the group consisting of —H and alkyl, and wherein n, x, y, and z are independently an integer from 1 to 40, inclusive. “Alkyl” refers to a straight- or branched-chain hydrocarbon of at least 1 carbon. Typically alkyl groups have no double or triple carbon-carbon bonds. Representative alkyl groups include, without limitation, methyl, ethyl, n-propyl, isopropyl, n-butyl, sec-butyl, isobutyl, tert-butyl, n-pentyl, isopentyl, neopentyl, n-hexyl, 3,3-dimethylbutyl, 3-methylhexyl, 2,2-dimethylpentyl, 2,3-dimethylpentyl, n-heptyl, n-octyl, n-nonyl, and n-decyl. In some embodiments, R₁, R₂, R₃, R₄, R₆, R₇, R₈, and R₉ are independently —H or methyl. In some embodiments, R₅ is n-octyl. In some embodiments, R₅ is n-nonyl. In other embodiments, R₁, R₂, R₃ and R₄ are each —H, and R₅ is n-octyl. In other embodiments, R₁, R₂, R₃ and R₄ are each —H, and R₅ is n-nonyl. In some embodiments, n is selected from the group of numbers consisting of 1, 2, 4, 5, 7, 8, 9, 10 and 15. In some embodiments, the non-ionic surfactant is a mixture of compounds of Formula (I) having different values for n. In a particular embodiment, the non-ionic surfactant comprises a 50:50 mixture of compounds of Formula (I) having two different values for n. In some embodiments, x is 5. In various embodiments, y is 12 or 40. In some embodiments, z is 7.

Non-limiting examples of surfactants embodying Formula (I) include Surfonic® N-95, Surfonic® N-150, Triton™ X-15, Triton™ X-45, Triton™ X-100, Triton™ X-102, and Triton™ X-114. Non-limiting examples of surfactants embodying Formula (II) include Surfactol® 318 and Surfactol® 365. In some embodiments, a non-ionic surfactant is selected from the group consisting of cocamide monoethanolamine, cocamide diethanolamine, Tween 20, Tween 80, Surfonic® N-9, Triton™ X-15, Triton™ X-45, Triton™ X-100, Triton™ X-102, Triton™ X-114, Surfactol® 318, Surfactol® 365, cetyl alcohol, oleyl alcohol, dodecyl dimethylamine oxide, octyl glucoside, decyl maltoside, and any mixture thereof. In other embodiments, a non-ionic surfactant is selected from the group consisting of Surfonic® N-95, Surfonic® N-150, Triton™ X-15, Triton™ X-45, Triton™ X-100, Triton™ X-102, Triton™ X-114, Surfactol® 318, and Surfactol® 365. In some embodiments, the non-ionic surfactant is Surfonic® N-150.

It is observed that a moisture-curable polyurethane binder composition prepared by a process of this disclosure may contain residual isocyanate functionality to a certain degree. The term “residual isocyanate functionality” herein refers to the percentage of isocyanate functional groups remaining in a binder composition after all components are combined. The ratio of isocyanate to polyol, the weight percent of the prepolymer mixture in the total volume of the binder composition, and the type of isocyanate and polyol are used to calculate the residual isocyanate functionality. A moisture-curable polyurethane binder composition may contain up to about 25% of residual isocyanate functionality. In an embodiment, a moisture-curable polyurethane binder composition contains about 3% to about 20% of residual isocyanate functionality.

In another embodiment, a moisture-curable polyurethane binder composition may contain about 5% to about 12% of residual isocyanate functionality. In yet another embodiment, a moisture-curable polyurethane binder composition may contain about 5% to about 7% of residual isocyanate functionality.

The addition of non-ionic surfactant or water to the binder composition may occur at various times. Non-ionic surfactant may be added to the prepolymer composition followed by addition of water. In other embodiments, surfactant and water may be added to the prepolymer simultaneously. In yet other embodiments, the surfactant and water may be mixed together separately then added to the prepolymer as a solution.

A binder composition can be prepared immediately before addition to particulate material. “Immediate” refers to prompt, quick or contiguous action without delay or intervention. In some embodiments, the prepolymer and water-emulsifier components are mixed together in-line while being metered into the mixture. In other embodiments, a prepolymer, a surfactant and water are mixed for 0 seconds to about 120 seconds before addition to particulate material. In other embodiments, a prepolymer, surfactant and water are pumped through a static mixing element at pressures between 15 and 200 psi and high flow rates directly before addition to particulate material. In other embodiments, the prepolymer and water-emulsified components are pumped through a static mixer immediately before incorporation with the particulate material.

Components of a process of the present disclosure, such as a prepolymer mixture, a surfactant and water, can be mixed at high pressure and shear since high pressure and shear may be useful for stabilizing an emulsion from the time of mixing. In an embodiment, components such as a prepolymer, a surfactant and water are mixed under a pressure of about 15 psi to about 150 psi through a series of static mixing elements.

Dynamic mixing machinery can also be used to generate adequate shear while components of a process of the present disclosure, such as a prepolymer, a surfactant and water, are emulsified.

Different percentages of components can be used in a disclosed process to produce a binder composition. In an embodiment, a process to make a moisture-curable polyurethane binder composition is carried out with about 15 to about 61 weight percent of an isocyanate-containing species, about 33 to about 79 weight percent of a polyol component, about 1 to about 10 weight percent of an non-ionic surfactant, and about 5 to about 51 weight percent of water, based on total weight of the binder. In another embodiment, the isocyanate-containing species to be used is about 15 to about 37 weight percent; the polyol component is about 18 to about 44 weight percent; non-ionic surfactant is about 2 to about 5 weight percent; and water is about 18 to about 39 weight percent, based on total weight of the binder.

This disclosure also provides a process to produce a moisture-curable polyurethane binder composition consisting essentially of: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; mixing the first mixture and a second mixture comprising water and a non-ionic surfactant. In an embodiment, a non-ionic surfactant contains a compound selected from the group consisting of

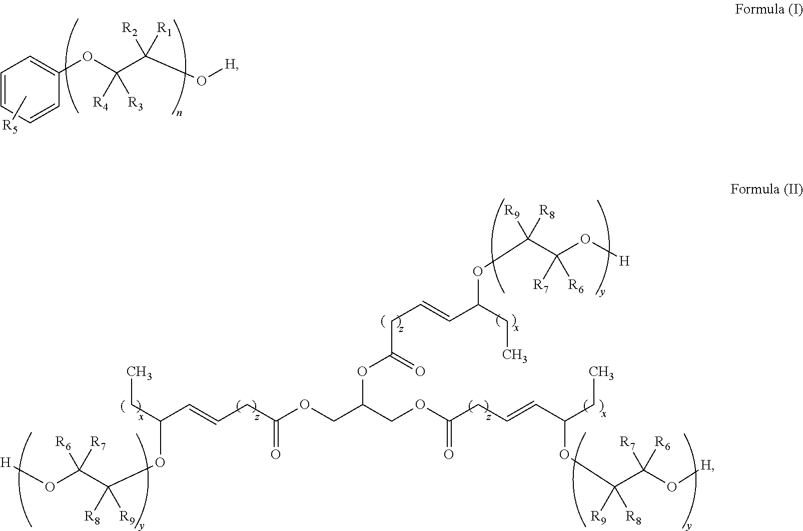

and a mixture thereof, wherein R₁, R₂, R₃, R₄, R₅, R₆, R₇, R₈, and R₉ are independently selected from the group consisting of —H and alkyl; and n, x, y, and z are independently an integer from 1 to 40, inclusive.

This disclosure further provides a process to produce a moisture-curable polyurethane binder composition comprising: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; adding a non-ionic surfactant to the first mixture; and adding water to the first mixture to form an emulsion, wherein the moisture-curable polyurethane binder composition contains about 3% to about 25% residual isocyanate functionality.

This disclosure provides a polyurethane binder composition prepared by a process comprising: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; mixing the first mixture and a second mixture comprising a non-ionic surfactant and water to form an emulsion, wherein the moisture-curable polyurethane binder composition contains about 3% to about 25% residual isocyanate functionality.

This disclosure also provides a polyurethane binder composition prepared by a process consisting essentially of: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; mixing the first mixture and a second mixture comprising water and a non-ionic surfactant. In an embodiment, a non-ionic surfactant contains a compound selected from the group consisting of

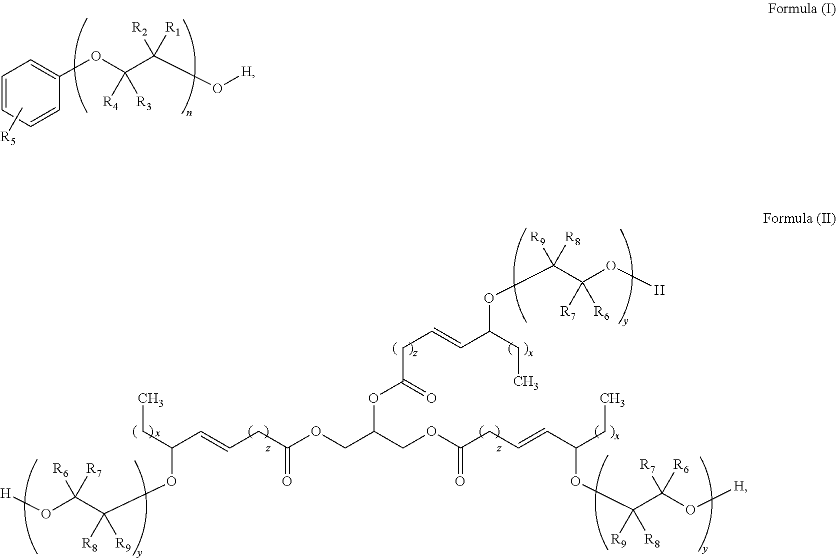

and a mixture thereof, wherein R₁, R₂, R₃, R₄, R₅, R₆, R₇, R₈, and R₉ are independently selected from the group consisting of —H and alkyl; and n, x, y, and z are independently an integer from 1 to 40, inclusive.

This disclosure further provides a polyurethane binder composition prepared by a process comprising: providing a first mixture comprising an isocyanate-containing species and a polyol component, wherein the polyol component is a polyfunctional polyol and the isocyanate-containing species is a difunctional or polyfunctional isocyanate, and wherein the isocyanate-containing species and the polyfunctional polyol are reacted to form an isocyanate-functionalized species; adding a non-ionic surfactant to the first mixture; and adding water to the first mixture to form an emulsion, wherein the moisture-curable polyurethane binder composition contains about 3% to about 25% residual isocyanate functionality. Also embraced are binder compositions prepared by any process described herein.

One or more agents can be optionally added to a polyurethane binder composition, for example, to meet various commercial needs. Therefore, agents to be added can be any conventional chemical that is compatible with a polyurethane binder composition. Examples of such agents include, but are not limited to, colorant, flame retardant, biocide, catalyst, plasticizer, extender, mold release, stabilizer, and any mixtures thereof.

A moisture-curable polyurethane binder composition prepared by a process of this disclosure can be applied to various target materials. For example, it can be used to combine particulate material. Thus, a process may further comprise applying a moisture-curable polyurethane binder composition to a particulate material to be combined. A coating machine used to coat the particulate material may be a batch or a continuous coating machine oriented at any angle. The number and type of agitators in the coating machine may be varied to suit the type of application. The time required to coat the particulate material with a disclosed binder composition may vary depending on the volume, density, or granularity of the particulate material. In some embodiments, a process may further comprise curing a moisture-curable polyurethane binder composition and a particulate material. Generally, this step results in production of various aggregated articles such as a molded block or log. This step can be done with any conventional curing method. For example, the binder/particulate matter mixture may be transferred to a mold and compressed until reacted or cured in a batch or a continuous process. In some embodiments, the mixture may also be cured by application of heat and/or steam.

This disclosure also provides a molded article, particularly an article prepared by a process comprising providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; mixing the first mixture and a second mixture comprising a non-ionic surfactant and water to form an emulsion, wherein the moisture-curable polyurethane binder composition contains about 3% to about 25% residual isocyanate functionality; applying the moisture-curable polyurethane binder composition to a particulate material to be combined; and curing the moisture-curable polyurethane binder composition and the particulate material.

In a particular embodiment, there is provided a molded article prepared by a process consisting essentially of providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; mixing the first mixture and a second mixture comprising water and a non-ionic surfactant. In an embodiment, a non-ionic surfactant contains a compound selected from the group consisting of

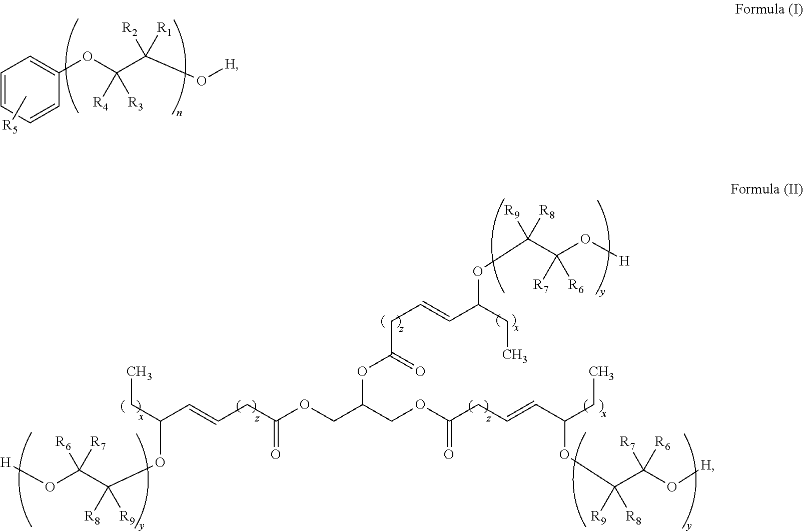

and a mixture thereof, wherein R₁, R₂, R₃, R₄, R₅, R₆, R₇, R₈, and R₉ are independently selected from the group consisting of —H and alkyl; and n, x, y, and z are independently an integer from 1 to 40, inclusive.

In another embodiment, an article is prepared by a process comprising providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; adding a non-ionic surfactant to the first mixture; adding water to a mixture of the first mixture and the non-ionic surfactant to form an emulsion, wherein the moisture-curable polyurethane binder composition contains about 3% to about 25% residual isocyanate functionality; applying the moisture-curable polyurethane binder composition to a particulate material to be combined; and curing the moisture-curable polyurethane binder composition and the particulate material to form a molded article.

A particulate material for a molded article includes, but is not limited to, rubber, foam scrap, plastic, paper, wood and any mixture thereof. In a particular embodiment, a molded article is a block. Any bonded foam can be molded into a useful form, including, but not limited to, a log, door frame, column, baluster, window header, pediment, medallion, rosettes, seat, headrest, armrest, automobile roof liner, dashboard, automobile instrument panel, surfboard, rigid-hulled boat, and grip.

In some embodiments, the molded article is a log, and the log is further processed by skiving to form a pad of specified thickness. “Skiving” refers to cutting or peeling material off moving rolls or strips to leave a desired edge shape or cross section. The log is rotated against the blade such that the blade peels off a length of a bonded product with a desired and uniform thickness. The bonded foam can be skived at a constant rate Likewise, the log can be continuously lowered with respect to the blade, such that the blade constantly skives a uniform thickness of bonded product. In some embodiments, the log first has an aperture through a center axis and a rod is inserted in the aperture. The rod enables the log to be handled without damaging it and allows easier transport of the log to a skiving machine. A pad produced by this process can be particularly useful as a flooring product or flooring underlayment because of its length and uniformity.

One with an ordinary level of skill in the art would appreciate that the foregoing examples and embodiments are exemplary and are not meant to limit the scope of this disclosure.

### EXAMPLES

### Example 1

### Preparation of Prepolymer Compositions

The following example describes four prepolymers used in preparing binder compositions. Isocyanate and polyol are reacted under conditions suitable to achieve the desired isocyanate functionality. The compositions were made in batch sizes of 400 grams as shown in Table 1, where the amount of each component is expressed in weight %.

TABLE 1
Prepolymer Formulations

| | Prepolymer 1 | | Prepolymer 2 | |
|---|---|---|---|---|
| Component | Name | wt % | Name | wt % |
| Polyol | 2000 MW | 41.25% | 2000 MW | 73.92% |
| | polypropylene | | polypropylene | |
| | glycol diol | | glycol diol | |
| Mold Release | Hydrotreated | 14% | None | |
| | naphthenic oil | | | |
| Isocyanate | PMDI | 44.75% | PMDI | 26.08% |
| | Prepolymer 3 | | Prepolymer 4 | |
| Component | Name | wt % | Name | wt % |
| Polyol | 4500 MW | 54.27% | 4500 MW | 77.13% |
| | polypropylene triol/ | | polypropylene triol/ | |
| | polyethylene glycol | | polyethylene glycol | |
| | copolymer | | copolymer | |
| Isocyanate | PMDI | 45.73% | PMDI | 22.87% |

The prepolymers were prepared by mixing polyol and isocyanate together at specified ratios. The polyol used was 4,500 molecular weight polypropylene glycol/triol polyethylene glycol copolymer or 2,000 molecular weight polypropylene glycol diol, and the isocyanate used was PMDI. The 4,500 molecular weight polypropylene glycol triol/polyethylene glycol copolymer contained a maximum of about 0.07 weight percent water, and had a hydroxyl number of 33.8-37.2 mg KOH/g, a maximum acid number of 0.015 mg KOH/g, a specific gravity of 1.03 at 20° C., a viscosity of 820 centipoise at 25° C., a flash point of about 191° C., and a bulk density of 8.56 pounds per gallon. The 2,000 molecular weight polypropylene glycol diol contained 0.03-0.1 weight percent water, and had a hydroxyl number of 54.5-57.5 mg KOH/g, a maximum acid number of 0.020-0.1 mg KOH/g, a specific gravity of 1.01 g/mL at 25° C., a viscosity of 335-370 centipoise at 25° C., a flash point of 188-216° C., and a bulk density of 8.37-8.38 pounds per gallon.

### Example 2

### Preparation of Emulsified Compositions by Simultaneous Addition of Water and Surfactant

The following example describes two compositions used in preparing bonded products. Prepolymer 1 was mixed with a solution of surfactant and water through a static mixer to form an emulsion. These compositions were made in batch sizes of 50 grams and their components are shown in Table 2, where the amount of each component is expressed in weight %.

TABLE 2
Emulsified compositions of prepolymer mixed with aqueous surfactant

| | Composition | |
|---|---|---|
| Component | 1 | 2 |
| Surfonic ® N-150 | 1.30% | 2.60% |
| Water | 50.70% | 49.40% |
| Prepolymer 1 | 48.00% | 48.00% |

Composition 1 formed a good emulsion with low viscosity. Composition 2 formed an excellent emulsion.

### Example 3

### Bonding Foam

Compositions 1 and 2 were prepared as described in Example 2 and tested as binders for making bonded foam pads. In these examples, a binder composition was mixed in an about 1 to about 10 ratio of binder to foam scrap immediately after emulsification over the period of about 30 seconds. The mixture of foam scrap and emulsified binder were mixed about 90 seconds more before transfer to a mold, compression, and steaming. Compression was used to obtain a target density of about 8 pounds per cubic foot. The pads were steamed to moisture-cure the binder composition. The pad continued to be steamed for about 90 seconds after the steam first penetrated the pad. The mass of binder composition, mass of scrap foam, time to transfer to the mold and compress, and the time for the steam to first penetrate the pad are listed in Table 3. Table 4 summarizes parameters for rebonded foam pads with ratios of binder composition to foam higher than 1:10, such as 1:9 and 1:8.2.

TABLE 3
Parameters for rebonded foam pads

| | | | Time to | Time for |
|---|---|---|---|---|
| | | Foam | transfer and | steam |
| | Composition (grams) | (grams) | compress | penetration |
| Pad 1 | Mistabond ® H3293 | 224.0 g | 18 seconds | 37 seconds |
| | (22.4 g) | | | |
| Pad 2 | Mistabond ® H3293 | 224.0 g | 23 seconds | 35 seconds |
| | (22.4 g) | | | |
| Pad 3 | Mistabond ® H3293 | 224.0 g | 26 seconds | 30 seconds |
| | (22.4 g) | | | |
| Pad 4 | Composition 1 (100 g) | 1000 g | 31 seconds | 40 seconds |
| Pad 5 | Composition 1 (30.6 g) | 224.0 g | 25 seconds | 15 seconds |
| Pad 6 | Composition 2 (22.4 g) | 224.0 g | 18 seconds | 30 seconds |

TABLE 4
Parameters for rebonded foam pads

| | Composition (grams) | Foam (grams) |
|---|---|---|
| Pad 7 | Composition 1 (100 g) | 933 g |
| Pad 8 | Composition 1 (100 g) | 896 g |
| Pad 9 | Composition 1 (100 g) | 862 g |
| Pad 10 | Composition 1 (100 g) | 818 g |
| Pad 11 | Composition 2 (100 g) | 896 g |
| Pad 12 | Composition 2 (100 g) | 830 g |
| Pad 13 | Composition 2 (100 g) | 772 g |
| Pad 14 | Composition 2 (100 g) | 734 g |

Pad tensile strength is reported in pounds-force per square inch (psi) and pad density is reported in pounds per cubic foot (pcf). The pad tensile strength and density are compared to Pads 1-3 made with Mistabond® H3293 (MarChem Corporation). Pads 1-3 were formed using conventional hydrocarbon extension technology, which involved mixing a prepolymer with a hydrocarbon plasticizer but not with water or surfactant. This conventional method does not form or require the formation of an emulsion. These control pads had variable densities and tensile strengths, depending how the pad was processed. The properties of the three control pads and the test pads are listed in Table 5.

TABLE 5
Properties of bonded foam pads produced by this method.

| | Weight | Tensile | Density | |
|---|---|---|---|---|
| | (grams) | (psi) | (pcf) | Demolding |
| Pad 1 | 246.4 g | 15.12 | 7.95 | easy |
| Pad 2 | 246.4 g | 13.35 | 8.19 | easy |
| Pad 3 | 246.4 g | 12.16 | 8.25 | easy |
| Pad 4 | 246.4 g | 15.33 | 7.88 | easy |
| Pad 5 | 254.6 g | 13.09 | 7.96 | easy |
| Pad 6 | 246.4 g | 11.49 | 7.95 | minor sticking |
| Pad 7 | 1033 g | 14.42 | 7.88 | slightly more difficult |
| | | | | than Pad 6 |
| Pad 8 | 996 g | 16.31 | 7.92 | slightly more difficult |
| | | | | than Pad 7 |
| Pad 9 | 962 g | 13.77 | 7.92 | slightly more difficult |
| | | | | than Pad 8 |
| Pad 10 | 918 g | 16.15 | 7.81 | slightly more difficult |
| | | | | than Pad 9 |
| Pad 11 | 996 g | 14.00 | 7.88 | slightly more difficult |
| | | | | than Pad 4 |
| Pad 12 | 930 g | 14.57 | 7.92 | slightly more difficult |
| | | | | than Pad 11 |
| Pad 13 | 872 g | 16.06 | 7.98 | slightly more difficult |
| | | | | than Pad 12 |
| Pad 14 | 834 g | 16.72 | 7.88 | similar to Pad 13 |

“Demolding” refers to the process of removing the molded article from the mold after moisture-curing. It is desirable that the article demold easily; that is, it is desirable that the article not stick to the mold and is removable without excessive force or prying, which could damage, mar or tear the molded article. “Minor sticking” refers to a molded article that slightly adhered to the mold and requires more force to remove than a molded article that can be removed easily.

Pad 4 was comparable to Pad 1 in tensile strength and density, and had no difficulty with removal from the mold. Pad 5 was comparable to Pad 2 in tensile strength and density, and had no difficulty with removal from the mold. Pad 6 was comparable to Pad 3 in tensile strength and density, and stuck slightly to the mold. These examples show that Compositions 1 and 2 are generally suitable for bonding particulate material as measured by pad tensile strength and density, without significant difficulty in demolding. For both Compositions 1 and 2, a 1:10 ratio of composition to foam produced pads with the easiest demolding properties. The compositions' performance is comparable to a binder which uses conventional hydrocarbon extension technology.

### Example 4

### Preparation of Emulsified Compositions by Stepwise Addition of Water and Surfactant

Prepolymers 2 and 3 were emulsified in water with various surfactants. In this study, a prepolymer was mixed with surfactant and then water was added. After the addition of water, the emulsions were hand-mixed for about 15 seconds using a spatula. These compositions were made in batch sizes of 50 grams and are shown in Table 6, where the amount of each component is expressed in weight %.

TABLE 6
Further emulsifications of prepolymer formulations

| Component | Composition 3 | | Composition 4 | | Composition 5 | |
|---|---|---|---|---|---|---|
| Surfactant | Triton ™ | 3.00% | Surfonic ® | 3.00% | Triton ™ | 3.00% |
| | X-114 | | N-95 | | X-100 | |
| Water | Water | 27.00% | Water | 27.00% | Water | 27.00% |
| Prepolymer | Prepolymer 2 | 70.00% | Prepolymer 3 | 70.00% | Prepolymer 3 | 70.00% |
| Component | Composition 6 | | Composition 7 | | Composition 8 | |
| Surfactant | Triton ™ | 3.00% | Triton ™ | 3.00% | Surfonic ® | 3.00% |
| | X-102 | | X-114 | | N-102 | |
| Water | Water | 27.00% | Water | 27.00% | Water | 27.00% |
| Prepolymer | Prepolymer 3 | 70.00% | Prepolymer 3 | 70.00% | Prepolymer 3 | 70.00% |

All compositions in Example 4 contained 3.00 weight % surfactant, 27.00 weight % water, and 70.00 weight % prepolymer. The properties of these compositions are shown in Table 7.

TABLE 7
Properties of Compositions 3-8

| Composition | Emulsion Quality | Rate of Separation | Viscosity |
|---|---|---|---|
| 3 | Fair | Slow/Stable | Low |
| 4 | Excellent | 4 minutes | Low |
| 5 | Excellent | 4 minutes | Low |
| 6 | Excellent | 4 minutes | Low |
| 7 | Excellent | Slow | Low at 1 minute; |
| | | | High at 2 minutes |
| 8 | Excellent | Slow | Very low |

“Emulsion quality” refers to mean droplet diameter and the extent of particle size distribution, with higher quality associated with smaller mean diameters and narrower particle size distributions. An “excellent” emulsion is one in which the prepolymer readily forms droplets with a low mean diameter and a narrow distribution of droplet sizes under the conditions of shear obtained in the process. A “fair” emulsion is one which the prepolymer forms larger droplets on average and a wider distribution of droplet sizes than an excellent emulsion under comparable shear conditions. A number of techniques, for example laser diffraction, can be used to quantify emulsion quality, and the 50% median value of the frequency (d₅₀) can be used as a major criterion to determine emulsion quality.

A “slow” or “stable” rate of separation denotes an emulsion which does not separate, cream, flocculate, break, or coalesce in the time required to bond particulate material.

A “low” viscosity composition is one which has a viscosity adequate for coating particulate material. A “high” viscosity composition is one which has a viscosity which substantially interferes with or inhibits adequate coating of particulate material.

This example shows that these compositions are generally suitable emulsions for bonding particulate material based on their emulsion quality, slow rate of separation, and low viscosity.

### Example 5

### Bonding Foam with Emulsified Compositions Formed by Stepwise Addition of Water and Surfactant

Compositions 4 and 7 were tested as binders for making foam pads. In these examples, an emulsified binder and flexible foam scrap were mixed in an about 1 to about 10 ratio immediately after emulsification of the binder. The emulsified composition (22.4 g) was added to foam (224.0 g) over the course of about 30 seconds and mixed for a total of about 90 seconds. The foam/binder mixture was transferred to a mold, compressed, and moisture-cured with steam for about 90 seconds after the steam first penetrated the material. The bonded foam pads were tested 3 days after formation. The results are summarized in Table 8.

TABLE 8
Performance of Compositions 4 and 7 in rebonding

| | Time to | Time for | Pad | Pad | Pad |
|---|---|---|---|---|---|
| | transfer mold | steam to first | weight | tensile | density |
| Composition | and compress | penetrate | (g) | (psi) | (pcf) |
| 4 | 27 seconds | 22 seconds | 363 | 7.66 | 7.89 |
| 7 | 24 seconds | 34 seconds | 363 | 11.00 | 7.79 |

Pad tensile strength is reported in psi and pad density is reported in pcf. The tensile strength and density were tested against a pad bonded with Mistabond® H3278, which had a tensile strength of 9.1 psi and a density of 5.7 pcf. Tensile strength, density, and molding quality were all within acceptable commercial values when compared to pads formed with a commercial, conventional, non-emulsified binder (Mistabond® H3278 control).

The foregoing description of the embodiments has been provided for purposes of illustration and description. It is not intended to be exhaustive or to limit the invention. Individual elements or features of a particular embodiment are generally not limited to that particular embodiment, but where applicable, are interchangeable and can be used in a selected embodiment, even if not specifically shown or described. The same may also be varied in many ways. Such variations are not to be regarded as a departure from the invention, and all such modifications are intended to be included within the scope of the invention.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A process for preparing a moisture-curable polyurethane binder composition comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising a non-ionic surfactant and water to form an emulsion,
wherein the moisture-curable polyurethane binder composition contains about 3% to about 25% residual isocyanate functionality.

2. The process for preparing a moisture-curable polyurethane binder composition of claim 1, wherein the moisture-curable polyurethane binder composition contains about 5% to about 12% residual isocyanate functionality.

3. The process for preparing a moisture-curable polyurethane binder composition of claim 1, wherein the first mixture and the second mixture are mixed 0 to about 120 seconds before use.

4. The process for preparing a moisture-curable polyurethane binder composition of claim 1, wherein the first mixture and the second mixture are mixed continuously while being pumped.

5. The process for preparing a moisture-curable polyurethane binder composition of claim 1, wherein the first mixture and the second mixture are mixed with a mixer selected from the group consisting of a static mixer, dynamic mixer, high intensity mechanical mixer, colloidal mill, high intensity mechanical emulsifier, impingement mixer, an agitator, batch mixers thereof, and in-line mixers thereof.

6. The process for preparing a moisture-curable polyurethane binder composition of claim 1, wherein the first mixture and the second mixture are mixed through a static or dynamic mixing device at a pressure of about 15 to about 250 psi.

7. The process for preparing a moisture-curable polyurethane binder composition of claim 1, wherein additional chemical other than the second mixture is not essentially added to the first mixture.

8. The process for preparing a moisture-curable polyurethane binder composition of claim 1, wherein the isocyanate-containing species is about 5 to about 61 weight percent; the polyol component is about 27 to about 79 weight percent; the non-ionic surfactant is about 1 to about 10 weight percent; and the water is about 11 to about 61 weight, based on the total weight of the binder.

9. The process for preparing a moisture-curable polyurethane binder composition of claim 8, wherein the isocyanate-containing species is about 11 to about 37 weight percent; the polyol component is about 37 to about 44 weight percent; non-ionic surfactant is about 1 to about 5 weight percent; and water is about 18 to about 51 weight percent, based on the total weight of the binder.

10. The process for preparing a moisture-curable polyurethane binder composition of claim 1, wherein the isocyanate-containing species is selected from the group consisting of toluene diisocyanate, diphenylmethayne diisocyanate, polymeric diphenyl diisocyanate, hexamethylene diisocyanate, isophorone diisocyanate, dicyclohexylmethane diisocyanate and mixtures thereof.

11. The process for preparing a moisture-curable polyurethane binder composition of claim 1, wherein the polyol is selected from the group consisting of difunctional polypropylene glycol, polyfunctional polypropylene glycol, polyethylene glycol and copolymers thereof, and the isocyanate-containing species is selected from the group consisting of diphenylmethane diisocyanate, polymeric diphenyl diisocyanate, and mixtures thereof.

12. The process for preparing a moisture-curable polyurethane binder composition of claim 1, wherein a non-ionic surfactant containing a compound selected from the group consisting of 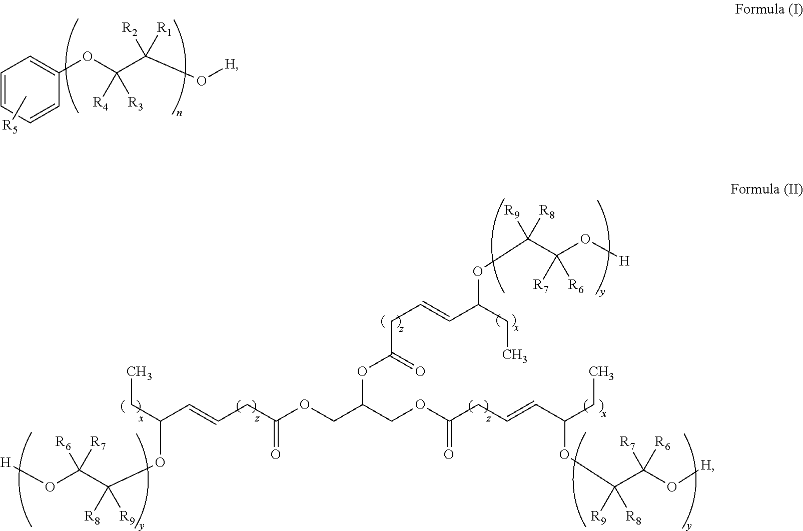
and a mixture thereof,
wherein R₁, R₂, R₃, R₄, R₅, R₆, R₇, R₈, and R₉ are independently selected from the group consisting of —H and alkyl; and n, x, y, and z are independently an integer from 1 to 40, inclusive.

13. The process for preparing a moisture-curable polyurethane binder composition of claim 12, wherein the surfactant contains two or more different monomeric compounds of Formula (I).

14. The process for preparing a moisture-curable polyurethane binder composition of claim 12, wherein the surfactant consists of a 50:50 mixture of two different monomeric compounds of Formula (I).

15. The process for preparing a moisture-curable polyurethane binder composition of claim 12, wherein the non-ionic surfactant selected from the group consisting of Surfonic® N-95, Surfonic® N-150, Triton™ X-15, Triton™ X-45, Triton™ X-100, Triton™ X-102, Surfactol® 318, Surfactol® 365 and mixtures thereof.

16. The process for preparing a moisture-curable polyurethane binder composition of claim 12, wherein the non-ionic surfactant is Surfonic® N-150.

17. The process for preparing a moisture-curable polyurethane binder composition of claim 1 which consists essentially of:
providing a first mixture comprising an isocyanate-containing species and a polyfunctional polyol, wherein the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising water and a non-ionic surfactant containing a compound selected from the group consisting of 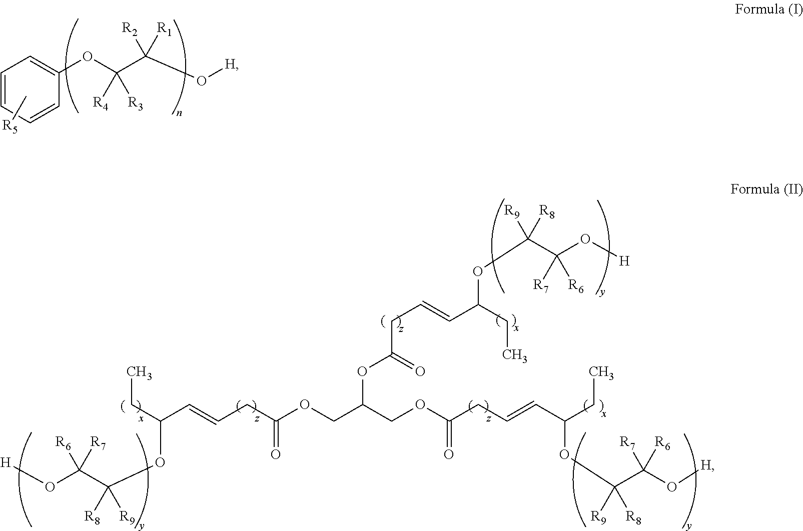
and a mixture thereof,
wherein R₁, R₂, R₃, R₄, R₅, R₆, R₇, R₈, and R₉ are independently selected from the group consisting of —H and alkyl; and n, x, y, and z are independently an integer from 1 to 40, inclusive.

18. The process for preparing a moisture-curable polyurethane binder composition of claim 17, wherein the non-ionic surfactant selected from the group consisting of Surfonic® N-95, Surfonic® N-150, Triton™ X-15, Triton™ X-45, Triton™ X-100, Triton™ X-102, Surfactol® 318, Surfactol® 365 and mixtures thereof.

19. The process for preparing a moisture-curable polyurethane binder composition of claim 17, wherein the non-ionic surfactant consists of a 50:50 mixture of two different monomeric compounds of Formula (I).

20. The process for preparing a moisture-curable polyurethane binder composition of claim 17, wherein the moisture-curable polyurethane binder composition contains about 8.6% to about 9.6% residual isocyanate functionality.

21. A polyurethane binder composition prepared by a process comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising a non-ionic surfactant and water,
whereby the moisture-curable polyurethane binder composition contains about 3% to about 25% residual isocyanate functionality.

22. The polyurethane binder composition of claim 21, wherein the process further comprises adding an agent selected from the group comprising colorant, flame retardant, biocide, catalyst, plasticizer, extender, mold release, stabilizer and mixtures thereof.

23. The polyurethane binder composition of claim 21, wherein the process consists essentially of:
providing a first mixture comprising an isocyanate-containing species and a polyfunctional polyol, wherein the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising water and a non-ionic surfactant containing a compound selected from the group consisting of 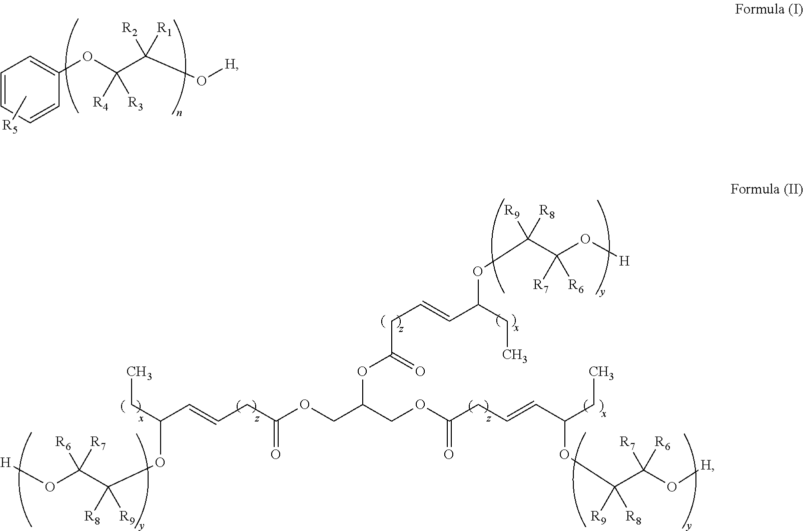
and a mixture thereof,
wherein R₁, R₂, R₃, R₄, R₅, R₆, R₇, R₈, and R₉ are independently selected from the group consisting of —H and alkyl; and n, x, y, and z are independently an integer from 1 to 40, inclusive.

24. A molded article prepared by a process comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species;
mixing the first mixture and a second mixture comprising a non-ionic surfactant and water, whereby the moisture-curable polyurethane binder composition contains about 3% to about 25% residual isocyanate functionality;
applying the moisture-curable polyurethane binder composition to a particulate material; and
curing the moisture-curable polyurethane binder composition and the particulate material.

25. The molded article of claim 24, wherein the particulate material is selected from rubber, foam scrap, plastic, paper, stone, wood and mixtures thereof.

26. The molded article of claim 24, wherein the article is a log, pad or block.

27. The molded article of claim 24, wherein the process consists essentially of:
providing a first mixture comprising an isocyanate-containing species and a polyfunctional polyol, wherein the isocyanate-containing species is a difunctional or polyfunctional isocyanate and wherein the isocyanate-containing species and the polyfunctional polyol are reacted to form an isocyanate-functionalized species; and
mixing the first mixture and a second mixture comprising water and a non-ionic surfactant containing a compound selected from the group consisting of 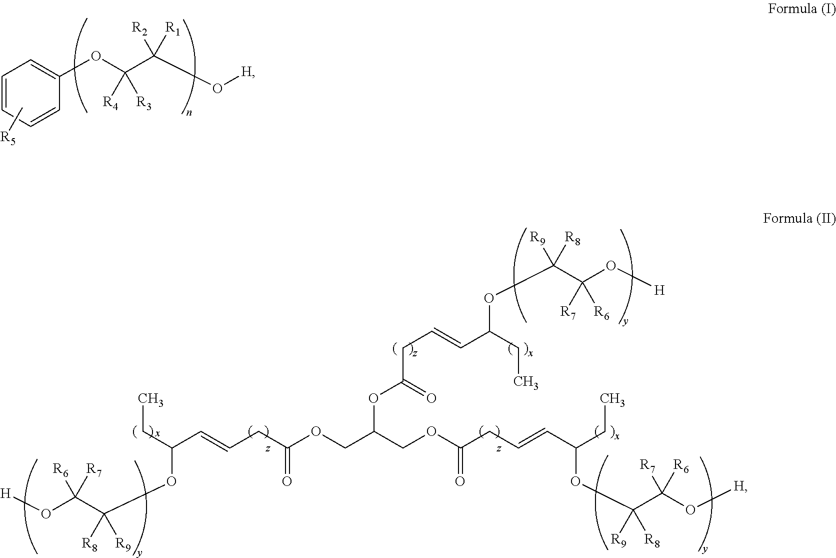
and a mixture thereof,
wherein R₁, R₂, R₃, R₄, R₅, R₆, R₇, R₈, and R₉ are independently selected from the group consisting of —H and alkyl; and n, x, y, and z are independently an integer from 1 to 40, inclusive.

28. The molded article of claim 27, wherein the molded article is a log and the log is further processed by skiving the log to form a pad of specified thickness.

29. A process for preparing a moisture-curable polyurethane binder composition comprising:
providing a first mixture comprising an isocyanate-containing species and a polyol component, wherein the polyol component is a polyfunctional polyol and the isocyanate-containing species is a difunctional or polyfunctional isocyanate and wherein the isocyanate-containing species and the polyfunctional polyol are reacted to form an isocyanate-functionalized species;
adding a non-ionic surfactant to the first mixture; and
adding water to a mixture of the first mixture and the non-ionic surfactant to form an emulsion,
wherein the moisture-curable polyurethane binder composition contains about 3% to about 25% residual isocyanate functionality.

30. The process for preparing a moisture-curable polyurethane binder composition of claim 29, wherein the isocyanate-containing species is about 11 to about 37 weight percent, the polyol component is about 37 to about 44 weight percent, non-ionic surfactant is about 1 to about 5 weight percent, and water is about 18 to about 51 weight percent, based on the total weight of the binder.

31. The process for preparing a moisture-curable polyurethane binder composition of claim 29, wherein the non-ionic surfactant selected from the group consisting of Surfonic® N-95, Surfonic® N-150, Triton™ X-15, Triton™ X-45, Triton™ X-100, Triton™ X-102, Surfactol® 318, Surfactol® 365 and mixtures thereof.
